(19) United States
(12) Patent Application Publication
(10) Pub. No.: US 2016/0086126 A1
(43) Pub. Date: Mar. 24, 2016

(54) INFORMATION PROCESSING APPARATUS AND METHOD

(71) Applicant: KABUSHIKI KAISHA TOSHIBA, Tokyo (JP)

(72) Inventor: Masayuki ASHIKAWA, Kawasaki Kanagawa (JP)

(73) Assignee: KABUSHIKI KAISHA TOSHIBA, Tokyo (JP)

(21) Appl. No.: 14/848,328

(22) Filed: Sep. 8, 2015

(30) Foreign Application Priority Data
Sep. 18, 2014 (JP) 2014-190448

(51) Int. Cl. G06Q 10/06

(52) U.S. Cl. CPC G06Q 10/063112

(57) ABSTRACT

According to one embodiment, an information processing apparatus a storage, a first extractor, a second extractor and a determiner. The storage stores worker information including an explanation that includes a keyword and that concerns a skill of a worker. The first extractor extracts, based on the keyword, worker skill word representing a characteristic of the skill of the worker, and worker skill value corresponding to the worker skill word. The second extractor extracts, based on the keyword included in a task summary, task skill word representing a characteristic of a task, and required skill value necessary for a process. The determiner determines, as a task candidate, a task indicating that task skill word matches the worker skill word and indicating that required skill value is no more than the worker skill value.

### CROSS-REFERENCE TO RELATED APPLICATIONS

This application is based upon and claims the benefit of priority from Japanese Patent Application No. 2014-190448, filed Sep. 18, 2014, the entire contents of which are incorporated herein by reference.

### FIELD

Embodiments described herein relate generally to an information processing apparatus and method.

### BACKGROUND

Workers have fields they are skilled at and those they are not skilled at. When a plurality of workers perform various types of tasks, workers should be allowed to perform a task in a field they are skilled at for work efficiency. However, if the variety and quantity of tasks increase, the classification of tasks becomes difficult. In addition, if the number of workers increases, determining the characteristics and abilities of the workers becomes difficult and the cost increases. There has been a technique of automatically assigning tasks based on a worker's capability.

### BRIEF DESCRIPTION OF THE DRAWINGS

FIG. 1 is a block diagram showing an information processing apparatus according to a first embodiment.

FIG. 2 shows examples of task conditions stored in a task condition storage.

FIG. 3 shows examples of worker skills stored in a worker information storage.

FIG. 4 is a flowchart showing an operation performed by the information processing apparatus when a worker performs an initial task.

FIG. 5 shows an output example of task candidates at an outputting unit.

FIG. 6 is a block diagram showing an information processing apparatus according to a second embodiment.

FIG. 7 is a flowchart showing an updating process of an updating unit.

FIG. 8 is a flowchart showing another example of the task candidate determination process.

FIG. 9 is a flowchart showing a task candidate determination process performed when a task in a specific category is performed.

FIG. 10 is a flowchart showing a task candidate determination process performed when a worker randomly performs a task.

FIG. 11 is a flowchart showing a process of outputting a task list.

FIG. 12 is a flowchart showing another example of the process of outputting a task list.

FIG. 13 is a block diagram showing an information processing system according to a third embodiment.

### DETAILED DESCRIPTION

The method for determining the level of capability of a worker or the level of difficulty of a task is not automated in the above-described technique, and the levels are defined based on a manager's determination. Thus, tasks may not be properly assigned. In addition, significant costs are incurred when there are a large number of workers and quantity of tasks, and all tasks are assigned based on the manager's determination.

In general, according to one embodiment, an information processing apparatus a first storage, a first extractor, a second extractor and a determiner. The first storage stores worker information including an explanation that includes at least one keyword and that concerns a skill of a worker. The first extractor extracts, based on the at least one keyword, at least one worker skill word representing a characteristic of the skill of the worker, and at least one worker skill value corresponding to the at least one worker skill word. The second extractor extracts, based on the keyword included in a task summary describing a task, at least one task skill word representing a characteristic of the task, and at least one required skill value necessary for a process represented by the at least one task skill word. The determiner determines, as a task candidate, a task indicating that task skill word matches the worker skill word and indicating that required skill value is no more than the worker skill value.

Hereinafter, an information processing apparatus, method, and program according to the present embodiments will be described in detail with reference to the drawings. In the following embodiments, the elements which perform the same operation will be assigned the same reference symbol, and redundant explanations will be omitted as appropriate.

In the embodiments, one process such as, “Write yomigana (a phonetic transcription written in kana) for XX” or “Evaluate the following voice” is called a “task item,” and a group of task items assigned with a title such as “Writing of yomigana” and “voice evaluation” is called a “task.”

### First Embodiment

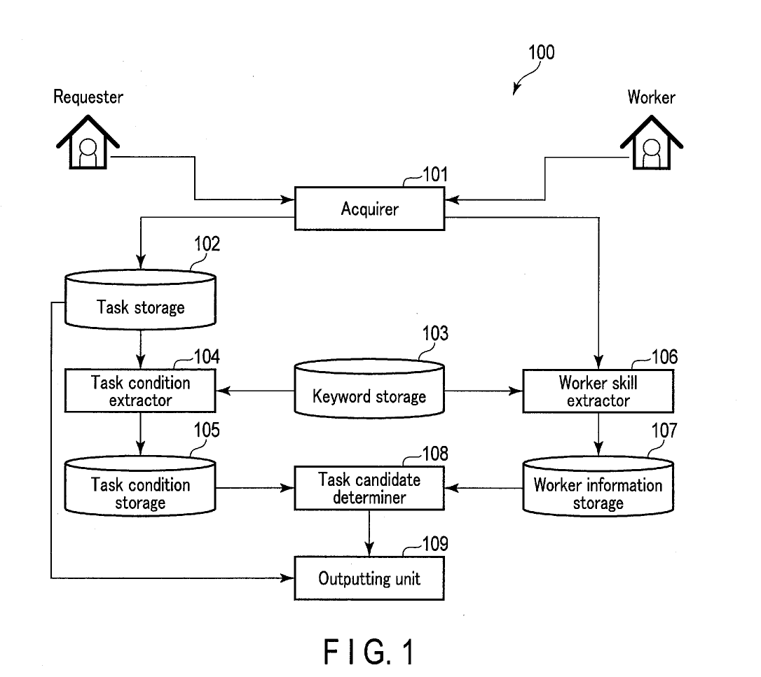

An information processing apparatus according to a first embodiment will be described with reference to the block diagram of FIG. 1.

The information processing apparatus 100 according to the first embodiment includes an acquirer 101, a task storage 102, a keyword storage 103, a task condition extractor 104, a task condition storage 105, a worker skill extractor 106, a worker information storage 107, a task candidate determiner 108, and an outputting unit 109.

From a person providing a task (hereinafter referred to as “requester”), the acquirer 101 acquires task data which is a main data of the task, and task information on the task. The task information includes information on, for example, a task title, task summary, required condition, compensation, and time limit. The task summary is an explanation of the task.

The acquirer 101 also acquires, from a person who performs a task (hereinafter referred to as a “worker”), worker information, which is information on the worker, and includes an explanation of the worker's skills. The worker information includes, for example, age, academic background, home, work history and self assessment information.

The task storage 102 receives task data and task information from the acquirer 101, and stores them so that they are associated with each other. Assumed in the present embodiment is the case where the task storage 102 stores the task data and task information so that they are associated with each other; however, the task data may be stored in an external database. In this way, the capacity required by the task storage 102 can be reduced.

The keyword storage 103 stores in advance a keyword in large-scale text data and the appearance frequency of the keyword so that they are associated with each other.

The task condition extractor 104 receives task information from the task storage 102, and performs a morphological analysis on the task information to obtain a morphological analysis result. The task condition extractor 104 refers to the keyword storage 103, and extracts a keyword which matches a word in the morphological analysis result (hereinafter referred to as “task skill word”) in accordance with the appearance frequencies of keywords, and extracts a value of a skill required for performing the process expressed by the task skill word (hereinafter referred to as “required skill value”). As the required skill value, for example, a value set by a requester may be used.

The task condition storage 105 receives a task skill word and a task skill value from the task condition extractor 104, and stores them so that they are associated with each other. Namely, the task condition storage 105 stores a task skill word and a required skill value for each task.

The task skill extractor 106 receives worker information from the acquirer 101. Like the task condition extractor 104, the worker skill extractor 106 performs a morphological analysis on the worker information to obtain a morphological analysis result. The worker skill extractor 106 refers to the keyword storage 103, and extracts a keyword (hereinafter referred to as “worker skill word”) which matches a word in the morphological analysis result, and extracts a worker skill value indicating a skill of the worker in respect to the worker skill word. For example, when a worker has not performed any task, the worker skill value may be set at the maximum. Determination methods in other cases will be described later.

The worker information storage 107 stores a worker skill word and a worker skill value for each worker so that they are associated with each other.

The task candidate determiner 108 receives a worker skill word and a worker skill value from the worker information storage 107, compares them with a task skill word and a required skill value stored in the task condition storage 105, and determines a task satisfying conditions as a task candidate. A task is regarded as “satisfying conditions” when the worker skill word matches the task skill word, and the worker skill value is equal to or larger than the required skill value.

The outputting unit 109 receives the task candidate from the task candidate determiner 108, and outputs it to, for example, a display of a terminal used by the worker. The output may be made by voice, instead of being displayed.

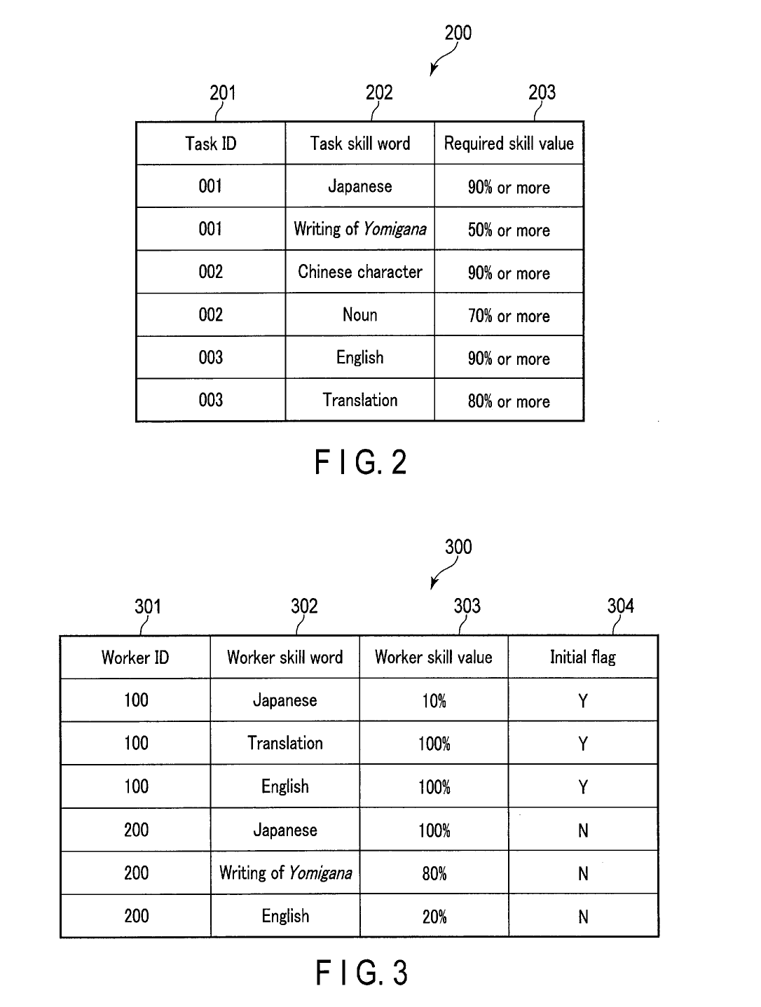

Next, examples of task conditions stored in the task condition storage 105 are described with reference to FIG. 2.

The table 200 shown in FIG. 2 stores therein a task ID 201, a task skill word 202, and a required skill value 203 for each task so that they are associated with one another, and the association is called “task condition.”

The task ID 201 is an identifier for uniquely identifying a task. The task skill word 202 is a word in the task summary which matches a keyword stored in the keyword storage 103. The required skill value 203 is a value required for the task skill word 202, and is expressed as a percent (%). When a task requires no conditions and can be performed by anyone, the required skill value 203 is set at zero.

For a specific example, task ID 201 “001” is associated with task skill word 202 “Japanese” and required skill value 203 “90% or more,” and the association is stored as a task condition.

Next, examples of worker skills stored in the worker information storage 107 will be described with reference to FIG. 3.

The table 300 shown in FIG. 3 stores therein a worker

ID 301, a worker skill word 302, a worker skill value 303, and an initial flag 304 for each worker so that they are associated with one another, and the association is called “worker skill.”

The worker ID 301 is an identifier for uniquely identifying a worker. The worker skill word 302 is a word in the worker information which matches a keyword stored in the keyword storage 103. The worker skill value 303 indicates a worker's ability regarding a task. The initial flag 304 indicates whether or not a worker is performing a certain task for the first time. Herein, when a worker performs the task for the first time, “Y” is displayed, whereas “N” is displayed for the second and subsequent times. However, any symbol may be displayed as long as whether or not a worker performs the task for the first time can be recognized.

For example, worker ID 301 “100” is associated with worker skill word 302 “Japanese,” worker skill value 303 “10%,” and initial flag 304 “Y,” and the association is stored as a worker skill.

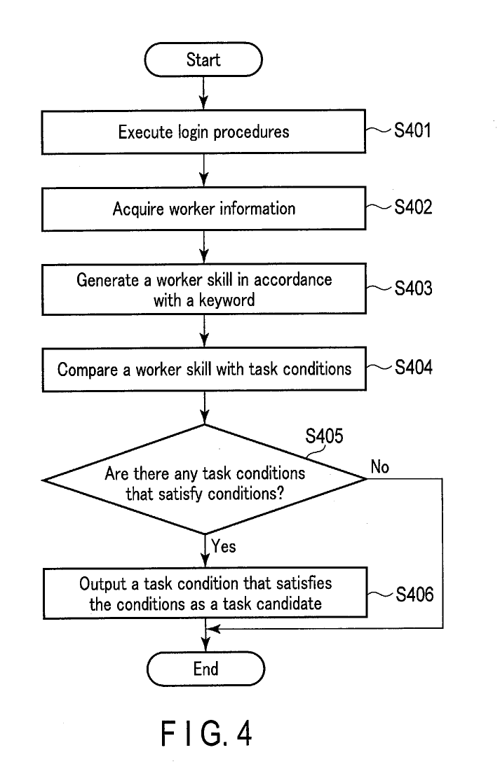

Next, an operation of the information processing apparatus 100 in the case where a worker performs a task for the first time will be described with reference to the flowchart of FIG. 4.

In the present case, a plurality of tasks are stored in advance in the task storage 102, and task conditions corresponding to the tasks are generated and stored in the task condition storage 105 in advance.

In step S401, the acquirer 101 acquires an ID and a password from a worker. Namely, the worker performs a login process. Let us assume that the worker successfully logs in.

In step S402, the acquirer 101 acquires worker information from the worker.

In step S403, the worker skill extractor 106 extracts a worker skill word and a worker skill value corresponding to the worker skill word based on the worker information and a keyword stored in the keyword storage 103, and generates a worker skill.

In step S404, the task candidate determiner 108 compares the worker skill with task conditions.

In step S405, the task candidate determiner 108 determines whether or not there is a task condition satisfying conditions for the worker skill. When a plurality of task conditions are stored, the worker skill is compared with each of the task conditions. If there is a task condition satisfying conditions, the process proceeds to step S406; if not, the process is terminated. If there is no task condition satisfying conditions, the outputting unit 109 may output a response “No task candidate found.”

In step S406, the outputting unit 109 outputs a task condition satisfying conditions as a task candidate. This is the end of the operation of the information processing apparatus of the case where a worker performs a task for the first time.

Next, a specific example of the case where a worker performs a task for the first time will be described with reference to FIGS. 2 to 4.

Assumed herein is the case where the appearance frequencies of the keywords “English” and “translation” stored in the keyword storage 103 are high, and the task conditions shown in FIG. 2 are stored in the task condition storage 105.

For example, when task title “translation task,” and task summary “Translate English text” are acquired regarding a task, the task condition extractor 104 performs a morphological analysis on the task summary. Since the appearance frequencies of the keywords “English” and “translation” stored in the keyword storage 103 are high, the words “English” and “translation” are extracted as task skill words, and required skill values corresponding to the task skill words are acquired and stored as task conditions for task ID 201 “003.”

The login process is completed by the worker inputting an ID for specifying an individual and a password. Next, the acquirer 101 acquires the age, academic background, hometown, work history, and self assessment from a worker as worker information. Let us assume that, “I have engaged in work relating to English translation.” is acquired as the self assessment.

The worker skill extractor 106 refers to the keyword storage 103, and obtains “English” and “translation,” which are keywords with high appearance frequencies, as worker skill words from the morphological analysis result of “I have engaged in work relating to English translation.” A skill value is set for an extracted worker skill word. Initially, however, “100%” is set as the skill value, and “Y” is set as the initial flag. This is because the operation is initially performed based on self-reported worker information.

Subsequently, the worker skills are compared with task conditions. The worker skill word “English” with worker skill value “100%” and worker skill word “translation” with worker skill value “80%” satisfy the task conditions of task ID “003” requiring task skill word “English” with a required skill value of “90% or more” and task skill word “translation” with a required skill value of “80% or more.” Because the worker skills satisfy the conditions, task ID “003” is determined as a task candidate.

When it is not the first time that the worker performs the task, and the worker has performed a task requiring similar skills, a process similar to that shown in FIG. 4 may be performed by using worker skill words and corresponding worker skill values stored in the worker information storage 107.

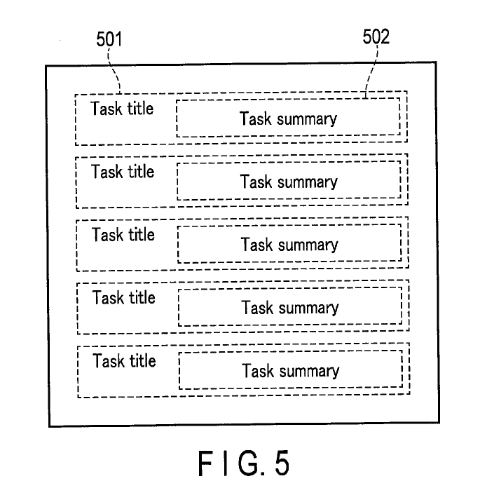

Next, an output example at the outputting unit 109 will be described with reference to FIG. 5.

FIG. 5 shows a display example of task candidates at the display. In the example of FIG. 5, the task titles 501 and task summaries 502 of task candidates that can be performed by the worker are displayed. The worker can select a task candidate from the displayed task candidates, and perform the task.

According to the above-described first embodiment, a skill word can be extracted from a task summary and worker information based on keywords, and a task satisfying conditions can be extracted as a task candidate. Thus, a worker suitable for the task can be prioritized when the task is assigned, and the overall accuracy of the task results can be improved. In addition, since a task skill word is calculated for a new task, the task can be assigned to a suitable worker, and the possibility of a low quality task result can be minimized. Furthermore, areas that workers are skilled at, which cannot be found manually, can be found. Moreover, for a worker whose accuracy is low in a specific area, tasks in that area are not displayed as task candidates, and the accuracy of task results can be improved. Because only tasks satisfying conditions are presented as task candidates, workers, who tend to flock to tasks offering high compensation, can be efficiently dispersed, and the task cost can be reduced.

### Second Embodiment

It is presumed that workers improve their skills and the tasks that workers can perform increase in number as they finish tasks. In contrast, task efficiency and accuracy may be low regarding a task which a worker is not skilled at or a task which a worker falsely reports that they are capable of. In the second embodiment, a more suitable task assignment can be achieved by performing an update process of reflecting a task result to a worker skill value.

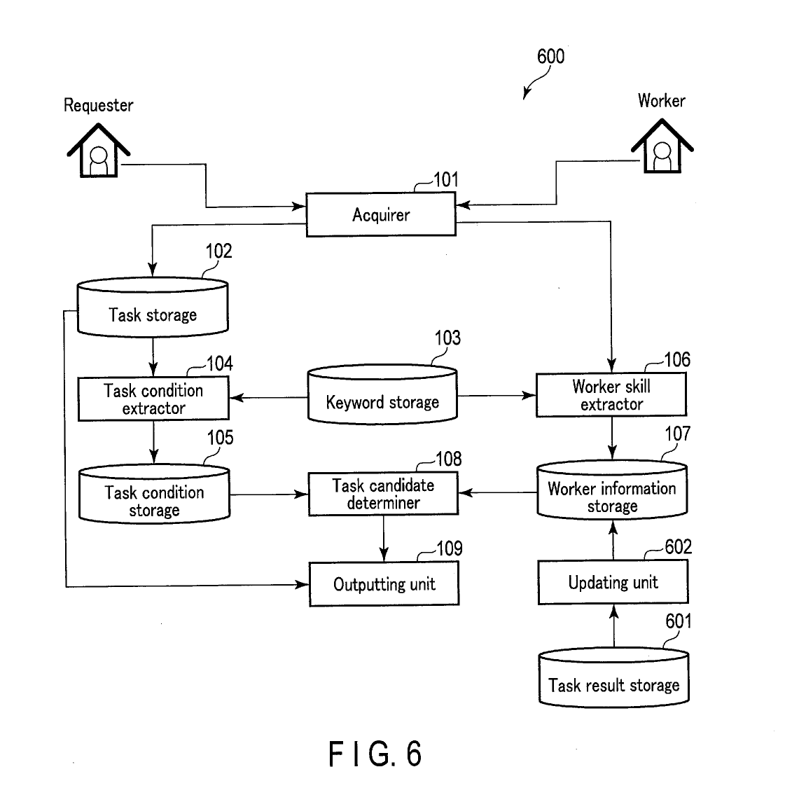

An information processing apparatus according to a second embodiment will be described with reference to the block diagram of FIG. 6.

The information processing apparatus 600 according to the second embodiment includes an acquirer 101, a task storage 102, a keyword storage 103, a task condition extractor 104, a task condition storage 105, a worker skill extractor 106, a worker information storage 107, a task candidate determiner 108, an outputting unit 109, a task result storage 601, and an updating unit 602.

The acquirer 101, task storage 102, keyword storage 103, task condition extractor 104, task condition storage 105, worker skill extractor 106, worker information storage 107, task candidate determiner 108 and outputting unit 109 perform the processes described in the first embodiment, and explanations thereof are omitted.

The task result storage 601 stores a task result of a task performed by a worker. Specifically, the task result storage 601 stores a worker ID and a task result of the worker so that they are associated with each other.

The updating unit 602 receives a task result of the worker and that of another worker from the task result storage 601 and updates the worker skill value in accordance with the accuracy of the task result.

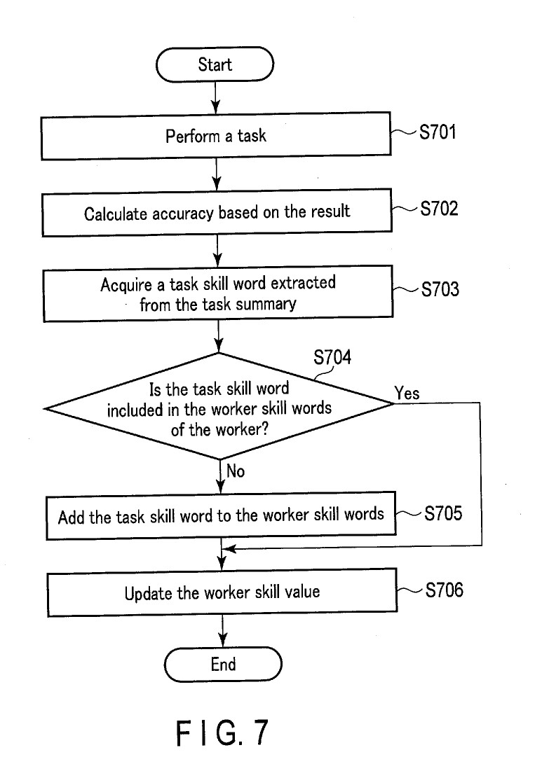

Next, an update process of the updating unit 602 will be described with reference to the flowchart of FIG. 7.

In step S701, a worker performs a task, and produces a task result.

In step S702, the updating unit 602 compares the task result of the worker with a task result of another worker to determine task accuracy. The task accuracy may be obtained by determining whether the task result of the worker is correct or incorrect in comparison with the task result of another worker, and obtaining an accuracy rate expressed by “number of correct tasks/number of performed tasks.”

In step S703, the updating unit 602 obtains a task skill word for the task performed by the worker from the task condition storage 105.

In step S704, the updating unit 602 determines whether or not the worker skill words of the worker include the task skill word. If they do, the process proceeds to step S706; if not, the process proceeds to step S705.

In step S705, the updating unit 602 adds a work skill word to the worker skill words. Specifically, the worker ID, a task skill word as a worker skill word, a worker skill value, and an initial flag are added to the table so that they are associated with one another.

In step S706, the updating unit 602 updates the worker skill value corresponding to the worker skill word of the worker. Specifically, the worker skill value is updated based on the task accuracy, and when the initial flag is “Y,” it is changed to “N.” When the number of tasks performed by the worker is small, the denominator is small, and the worker skill value dramatically fluctuates. Thus, when the number of tasks performed by the worker is smaller than a first number, the worker skill value is not updated (is failed to update). For example, a worker who performs a task for the first time keeps worker skill value “100%” until the number of tasks performed by the worker reaches a predetermined number. By the above, the update process of the updating unit 602 ends.

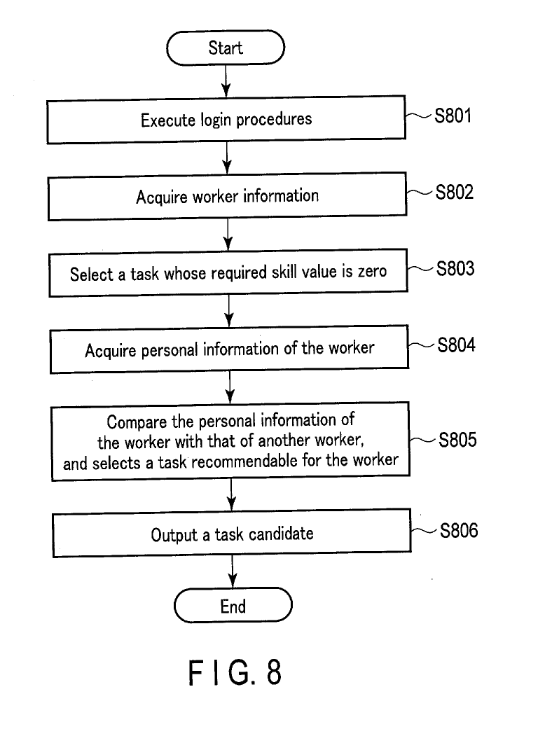

Next, another example of the task candidate determination process will be described with reference to the flowchart of FIG. 8.

In step S801, a worker performs a login process.

In step S802, the acquirer 101 acquires worker information from the worker.

In step S803, the task candidate determiner 108 selects a task whose required skill value is “0%.”

In step S804, the acquirer 108 acquires personal information of the worker from the worker information storage 107.

In step S805, the task candidate determiner 108 compares the personal information of the worker with that of another worker, and selects a task recommendable for the worker. Such a comparison is performed because, for example, when the work history or self assessment of the worker is the same as, or similar to that of another worker, the worker is presumed to be as capable of the same tasks as another worker.

In step S806, the outputting unit 109 outputs a task candidate that can be performed by the worker. By the above process, a task suitable for the worker can be output.

Determination of whether or not a task can be performed by a worker may be performed by having the worker perform a preliminary process for conditioning performance of a task in a specific category.

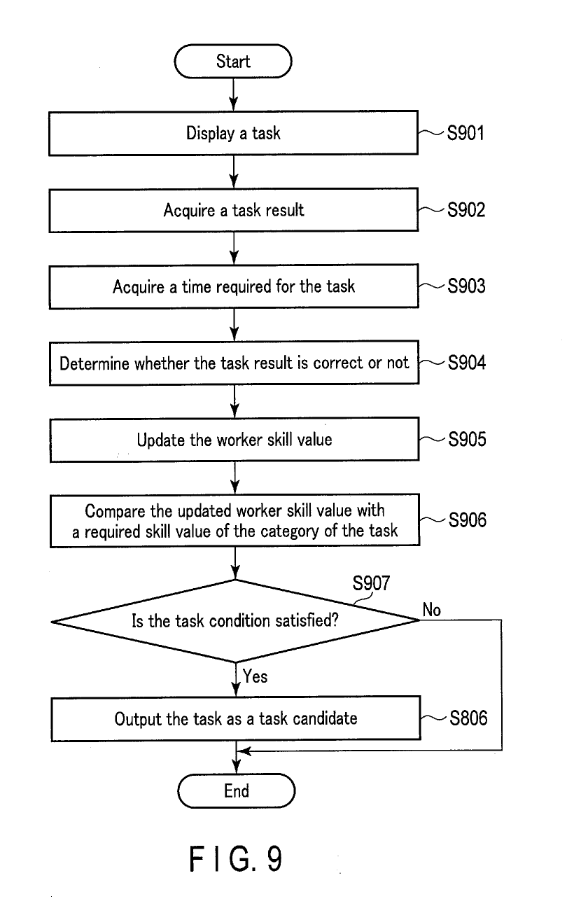

A task candidate determination process in the case where a task in a specific category is performed will be described with reference to the flowchart of FIG. 9. Note that step S806 is the same as that executed in FIG. 8, and a description thereof is omitted.

In step S901, the outputting unit 109 displays a task for a worker.

In step S902, the acquirer 101 acquires a task result produced by the worker performing the task.

In step S903, the updating unit 602 acquires a time required for the task. The required time may be obtained by, for example, the updating unit 602 measuring a time from the worker's start of the task to the acquirement of the result by a timer or the like.

In step S904, the updating unit 602 determines whether the task result is correct or not.

In step S905, the updating unit 602 updates the worker skill value.

In step S906, the task candidate determiner 108 compares the updated worker skill value with a required skill value necessary for the category of the task provided to the worker.

In step S907, the task candidate determiner 108 determines whether or not the worker satisfies the task condition of the task. If the worker satisfies the task condition, the process proceeds to step S806; if not, the process is terminated.

In step S806, the outputting unit 109 outputs the task to the worker as a task candidate. By the above process, a skill of a worker for a task can be determined in advance, and when a task in a specific category is performed, a suitable task candidate according to the skill of the worker can be output.

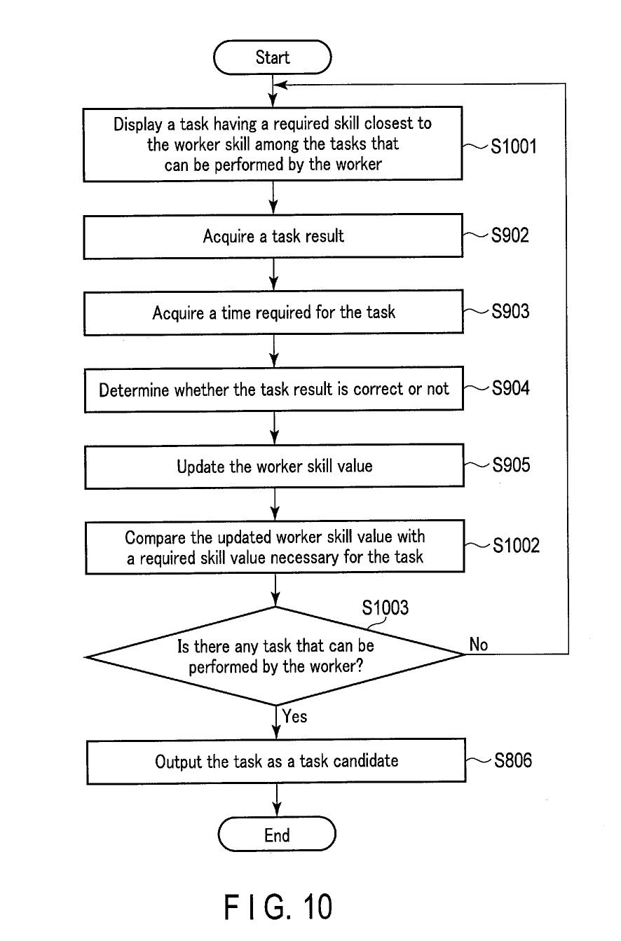

Next, a task candidate determination process performed when a worker randomly performs a task will be described with reference to the flowchart of FIG. 10.

Steps S902 to S905 and S806 are the same as those in FIG. 9, and descriptions thereof are omitted.

In step S1001, the outputting unit 109 displays a task having a required skill closest to the worker skill among the tasks that can be performed by the worker.

In step S1002, the task candidate determiner 108 compares the required skill value necessary for the task with the updated worker skill value.

In step S1003, the task candidate determiner 108 determines whether or not there is a task that can be performed by the worker. Namely, the task candidate determiner 108 determines whether or not there is a task whose required skill value is equal to or smaller than (no more than) the worker skill value. If there is a task that can be performed by the worker, the process proceeds to step S806; if not, the process returns to step S1001, and the same process is repeated. By the above process, a suitable task can be assigned even when a worker randomly performs a task.

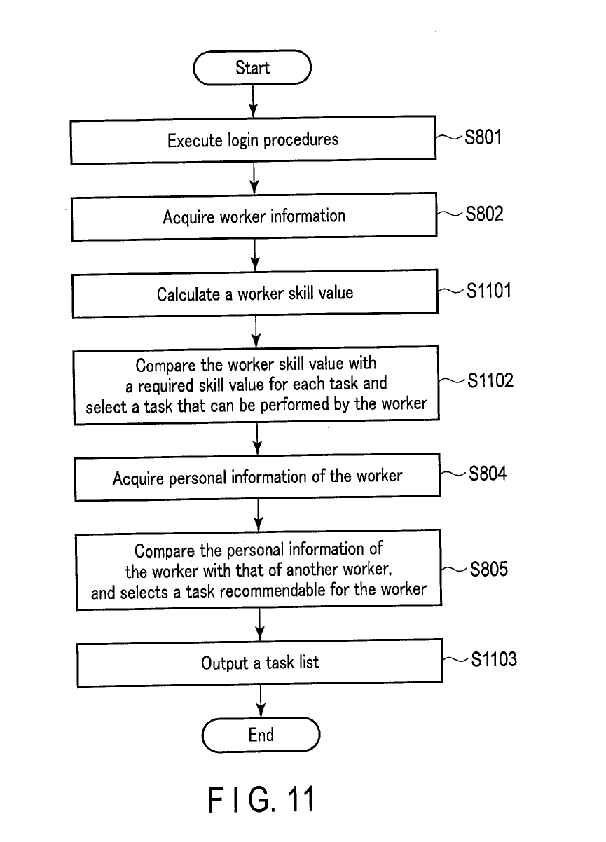

Next, a process of outputting a list of tasks that can be performed by a worker (hereinafter referred to as “task list”) will be described with reference to the flowchart of FIG. 11.

Steps S801, S802, S804, and S805 are the same as those in FIG. 8, and descriptions thereof are omitted.

In step S1101, the worker skill extractor 106 calculates a worker skill value. For example, the worker skill value may be a value self-reported by a worker or may be an extracted updated worker skill value.

In step S1102, the task candidate determiner 108 compares the worker skill value with the required skill value of each task, selects tasks recommendable for the worker, and generates a task list.

In step S1103, the outputting unit 109 outputs the task list.

By the above process, a task list of tasks that can be performed by the worker can be displayed.

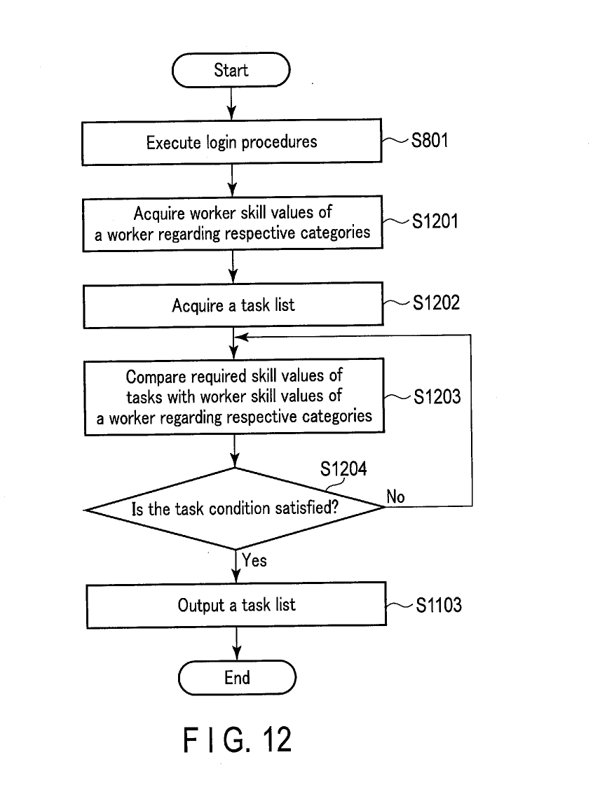

Next, another example of the output of a task list will be described with reference to the flowchart of FIG. 12. Steps S801 and S1103 are the same as those in FIG. 11, and descriptions thereof are omitted.

In step S1201, the worker skill extractor 106 acquires a worker skill value of each worker regarding each category.

In step S1202, the outputting unit 108 generates a task list.

In step S1203, for each of the categories of a task, the task candidate determiner 108 compares the worker skill value regarding the category with the required skill value of the task.

In step S1204, the task candidate determiner 108 determines whether or not the worker skill value satisfies the task condition. If the worker skill value satisfies the task condition, the process proceeds to step S1103; if not, the process returns to step S1203, and the same process is repeated.

According to the above-described second embodiment, a more suitable task assignment can be achieved by performing the update process of reflecting a task result to a worker skill value.

### Third Embodiment

In the third embodiment, an information processing system of a server and a client, based on the assumption that so-called crowdsourcing is used, will be described. In the information processing system, a manager manages a server, a requester registers a task in a server via a client, and a worker performs a task via a client.

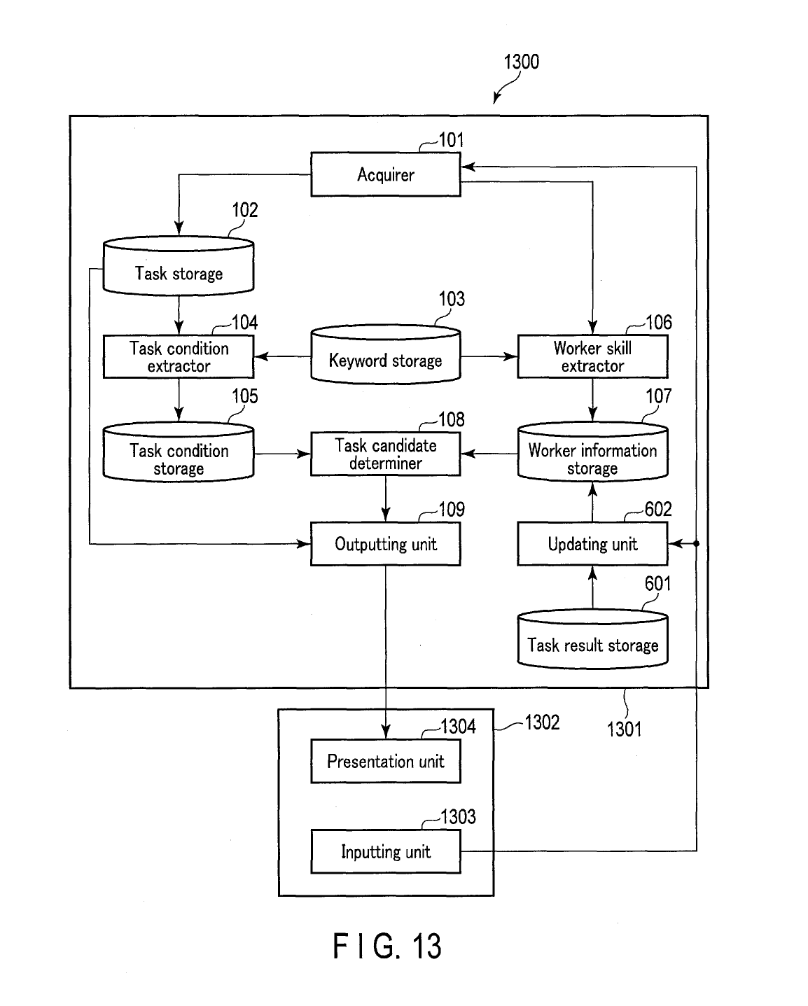

An information processing system according to the third embodiment will be described with reference to FIG. 13.

The information processing system 1300 shown in FIG. 13 includes an information processing server 1301 and a terminal 1302. The information processing server 1301 may be connected to a plurality of terminals 1302. In this case, each terminal 1302 communicates with the information processing server 1301.

The information processing server 1301 is similar to the information processing apparatus 600 of the second embodiment, and descriptions thereof are omitted.

The terminal 1302 includes an inputting unit 1303 and a presentation unit 1304.

The inputting unit 1303 acquires an input of worker information or an input of a task result from a worker.

The presentation unit 1304 receives a task candidate from the outputting unit 109 of the information processing server 1301, and presents the task candidate. The task candidate may be displayed on a display, or may be output as voice.

The worker inputs data in the terminal 1302, whereby data is transmitted from the terminal 1302 to the information processing server 1301.

According to the above-described third embodiment, in crowdsourcing, when a worker is assigned to a task, a worker suitable for the task can be prioritized without the manager manually assigning the worker to the task, and the overall accuracy of the task results can be improved.

The flow charts of the embodiments illustrate methods and systems according to the embodiments. It is to be understood that the embodiments described herein can be implemented by hardware, circuit, software, firmware, middleware, microcode, or any combination thereof. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a first storage which stores worker information including an explanation that includes at least one keyword and that concerns a skill of a worker;
a first extractor which extracts, based on the at least one keyword, at least one worker skill word representing a characteristic of the skill of the worker, and at least one worker skill value corresponding to the at least one worker skill word;
a second extractor which extracts, based on the keyword included in a task summary describing a task, at least one task skill word representing a characteristic of the task, and at least one required skill value necessary for a process represented by the at least one task skill word; and
a determiner which determines, as a task candidate, a task indicating that task skill word matches the worker skill word and indicating that required skill value is no more than the worker skill value.

2. The apparatus according to claim 1, further comprising a presentation unit which presents the task candidate.

3. The apparatus according to claim 1, wherein the worker information further includes at least one of age, academic background, home, work history, and self assessment of the worker.

4. The apparatus according to claim 1, further comprising:
a second storage which stores a processing result produced by the worker performing the task candidate, the processing result including task accuracy; and
an updating unit which updates the worker skill value in accordance with the processing result.

5. The apparatus according to claim 4, wherein
the updating unit fails to update the worker skill value when a number of candidate tasks performed by the worker is smaller than a first value.

6. The apparatus according to claims 2, further comprising an inputting unit which performs data input which indicates a task corresponding to the presented task candidate.

7. An information processing method, comprising:
storing, in a first storage, worker information including an explanation that includes at least one keyword and that concerns a skill of a worker;
extracting, based on the at least one keyword, at least one worker skill word representing a characteristic of the skill of the worker, and at least one worker skill value corresponding to the at least one worker skill word;
extracting, based on the keyword included in a task summary describing a task, at least one task skill word representing a characteristic of the task, and at least one required skill value necessary for a process represented by the at least one task skill word; and
determining, as a task candidate, a task indicating that task skill word matches the worker skill word and indicating that required skill value is no more than the worker skill value.

8. The method according to claim 7, further comprising presenting the task candidate.

9. The method according to claim 7, wherein the worker information further includes at least one of age, academic background, home, work history, and self assessment of the worker.

10. The method according to claim 7, further comprising:
storing, in a second storage, a processing result produced by the worker performing the task candidate, the processing result including task accuracy; and
updating the worker skill value in accordance with the processing result.

11. The method according to claim 10, wherein
the updating the worker skill value fails to update the worker skill value when a number of candidate tasks performed by the worker is smaller than a first value.

12. The method according to claims 8, further comprising performing data input which indicates a task corresponding to the presented task candidate.

13. A non-transitory computer readable medium including computer executable instructions, wherein the instructions, when executed by a processor, cause the processor to perform a method comprising:
storing, in a first storage, worker information including an explanation that includes at least one keyword and that concerns a skill of a worker;
extracting, based on the at least one keyword, at least one worker skill word representing a characteristic of the skill of the worker, and at least one worker skill value corresponding to the at least one worker skill word;
extracting, based on the keyword included in a task summary describing a task, at least one task skill word representing a characteristic of the task, and at least one required skill value necessary for a process represented by the at least one task skill word; and
determining, as a task candidate, a task indicating that task skill word matches the worker skill word and indicating that required skill value is no more than the worker skill value.

14. The medium according to claim 13, further comprising presenting the task candidate.

15. The medium according to claim 13, wherein the worker information further includes at least one of age, academic background, home, work history, and self assessment of the worker.

16. The medium according to claim 13, further comprising:
storing, in a second storage, a processing result produced by the worker performing the task candidate, the processing result including task accuracy; and
updating the worker skill value in accordance with the processing result.

17. The medium according to claim 16, wherein
the updating the worker skill value fails to update the worker skill value when a number of candidate tasks performed by the worker is smaller than a first value.

18. The medium according to claims 14, further comprising performing data input which indicates a task corresponding to the presented task candidate.
